(19) United States
(12) Patent Application Publication
(10) Pub. No.: US 2025/0117778 A1
(43) Pub. Date: Apr. 10, 2025

(54) ACCESS CONTROL SYSTEMS AND METHODS FOR CRYPTOWALLETS

(71) Applicant: Thirdwayv, Inc., Irvine, CA (US)

(72) Inventors: Nabil Wasily, Foothill Ranch, CA (US); Michael Atef Ayoub, Irvine, CA (US)

(21) Appl. No.: 18/726,280

(22) PCT Filed: Feb. 9, 2023
(86) PCT No.: PCT/US2023/012738

§ 371 Date: Jul. 2, 2024

Related U.S. Application Data
(60) Provisional application No. 63/308,469, filed on Feb. 9, 2022.

(51) Int. Cl. G06Q 20/36; G06Q 20/38; G06Q 20/40; H04L 9/08; H04L 9/14

(52) U.S. Cl. CPC G06Q 20/36; G06Q 20/3829; G06Q 20/4012; H04L 9/0861; H04L 9/14; H04L 2209/56

(57) ABSTRACT

Systems, methods, and devices for access control of crypto wallets. A crypto wallet may interoperate with multiple wallet controller devices. By implementing various key exchange mechanisms, instructions from the wallet controller devices may be securely provided to the crypto wallets, and the crypto wallets may verify the source of the instructions. By implementing these mechanisms, a risk of theft or unauthorized transfer of cryptocurrency associated with the hardware wallet is ameliorated.

### CROSS-REFERENCE TO RELATED APPLICATIONS

This application is based upon and claims priority to U.S. provisional patent application 63/308,469 entitled “ACCESS CONTROL SYSTEMS AND METHODS FOR CRYPTOWALLETS” and filed Feb. 9, 2022, the entire content of which is incorporated herein by reference.

### BACKGROUND

### 1. Field

The present disclosure is directed to crypto wallets, and more specifically, the present disclosure is directed to access control for crypto wallets.

### 2. Description of the Related Art

Access control on hardware crypto wallets usually relies on a PIN that the wallet owner enters using the buttons or electronic keys on the device. If the PIN is successively entered incorrectly for a certain number of times, the device resets itself and deletes all the wallet's information including the seed value. This can be problematic if the owner forgets the PIN or if a bad actor enters too may incorrect PINs.

### SUMMARY

Systems, apparatuses, and/or methods for access control for crypto wallets are provided. A method of configuring a hardware wallet for control is provided. The method may include generating, by a first wallet controller, a master signing key pair including a private master signing key and a public master signing key. The method may include generating, by the first wallet controller, a first unlocking key pair including a private first unlocking key and a public first unlocking key. The method may include signing, by the first wallet controller, the public first unlocking key with the private master signing key to create a signed public first unlocking key. The method may include transmitting, from the first wallet controller to the hardware wallet, the public master signing key. The method may include transmitting, from the first wallet controller to the hardware wallet, the signed public first unlocking key.

In various embodiments, the method includes one or more further aspects. For instance, the method may include storing, by the hardware wallet, the public master signing key. The hardware wallet may store the signed public first unlocking key. The hardware wallet may decrypt, from the signed public first unlocking key, the public first unlocking key, by the public master signing key master signing key. The hardware wallet may store the public first unlocking key.

Other aspects may also be provided. The method may include setting, by a user input component of the hardware wallet, a first user personal identification number (PIN) and storing the first user PIN. The method may include transmitting, from the first wallet controller, the private master signing key to a second wallet controller. The second wallet controller may generate a second unlocking key pair having a private second unlocking key and a public second unlocking key. The second wallet controller may sign the public second unlocking key with the private master signing key to create a signed public second unlocking key. The second wallet controller may transmit the signed public second unlocking key to the hardware wallet. Transmitting the private master signing key from the first wallet controller to the second wallet controller may mean accessing a same trusted execution environment (TEE) by the first wallet controller and the second wallet controller.

In various embodiments, the method further contemplates storing, by the hardware wallet, the signed public second unlocking key, decrypting, from the signed public second unlocking key, the public second unlocking key, by the public master signing key, and storing, by the hardware wallet, the public second unlocking key.

The method may include authorizing unlocking of the hardware wallet to allow access to secured data comprising cryptocurrency. The authorizing may include generating, by the first wallet controller, a first wallet unlocking command. The authorizing may include signing, by the first wallet controller, the first wallet unlocking command with the private first unlocking key to generate a first signed wallet unlocking command. The authorizing may include transmitting, by the first wallet controller, the first signed wallet unlocking command to the hardware wallet.

The method may include accessing secured data that includes cryptocurrency, the accessing occurring after the authorizing unlocking of the hardware wallet. The accessing may include prompting, by the hardware wallet, a user to enter a personal identification number. The accessing may include receiving, by the hardware wallet, the personal identification number. The accessing may include verifying, by the hardware wallet, that the received personal identification number is correct. Further aspects may be performed in response to the verifying. For instance, the method may continue with decrypting, from the signed wallet unlocking command, the first wallet unlocking command, by the public first unlocking key to reveal the first wallet unlocking command and executing, by the hardware wallet, the first wallet unlocking command.

In various embodiments with a second wallet controller, authorizing unlocking of the hardware wallet to allow access to secured data including cryptocurrency may have aspects related to the second wallet controller. For instance, the authorizing may include generating, by the second wallet controller, a second wallet unlocking command. The authorizing may include signing, by the second wallet controller the second wallet unlocking command with the private second unlocking key to generate a second signed wallet unlocking command. The authorizing may include transmitting, by the second wallet the second signed wallet unlocking command to the hardware wallet.

In various embodiments with a second wallet controller, accessing the secured data including cryptocurrency may have aspects related to the second wallet controller. For instance, the accessing may occur after the authorizing unlocking of the hardware wallet and may include various operations. The accessing may include prompting, by the hardware wallet, a user to enter a personal identification number. The accessing may include receiving, by the hardware wallet, the personal identification number. The accessing may include verifying, by the hardware wallet, that the received personal identification number is correct. Further aspects may be performed in response to the verifying. For instance, the method may continue with decrypting, from the signed wallet unlocking command, the second wallet unlocking command, by the public second unlocking key to reveal the second wallet unlocking command. The method may continue with executing, by the hardware wallet, the second wallet unlocking command.

Various methods may also have aspects relating to revocation of keys. For instance, the method may include revoking the first unlocking key pair. Revoking the first unlocking key pair may include generating, by the first wallet controller, a first unlocking key pair revocation command. The method may include signing, by the first wallet controller, the first unlocking key pair revocation command with at least one of (i) the private master signing key and/or (ii) the private first unlocking key to generate a first signed unlocking key pair revocation command. The method may include transmitting, by the first wallet controller, the first signed unlocking key pair revocation command to the hardware wallet. The revoking may further include receiving, by the hardware wallet the first signed unlocking key pair revocation command. The revoking may include decrypting, from the first signed unlocking key pair revocation command, the first unlocking key pair revocation command, by at least one of (i) the public master signing key and/or (ii) the public first unlocking key to reveal the first unlocking key pair revocation command. The method may include deleting, by the hardware wallet, the public first unlocking key from the hardware wallet.

A further method of configuring a hardware wallet for control by a first wallet controller is provided. The method may include receiving, by a hardware wallet and from a first wallet controller, a public master signing key from a master signing key pair comprising a private master signing key and the public master signing key. The method may include receiving, by the hardware wallet and from the first wallet controller, a signed public first unlocking key comprising a public first unlocking key from a first unlocking key pair comprising a private first unlocking key and a public first unlocking key, wherein the public first unlocking key is signed by the private master signing key. The method may include storing, by the hardware wallet, the public master signing key. The method may include storing, by the hardware wallet, the signed public first unlocking key. The method may include decrypting, from the signed public first unlocking key, the public first unlocking key, by the public master signing key master signing key. The method may include storing, by the hardware wallet the public first unlocking key.

Further aspects may also be provided. For instance, the method may include setting, by a user input component of the hardware wallet, a first user personal identification number (PIN) and storing the first user PIN. The method may include authorizing unlocking of the hardware wallet to allow access to secured data comprising cryptocurrency. The authorizing may include receiving, by the hardware wallet and from the first wallet controller, a first signed wallet unlocking command, wherein the first signed wallet unlocking command comprises a first wallet command that is signed by the first wallet controller with the private first unlocking key.

The method may include accessing, by the hardware wallet, secured data including cryptocurrency, the accessing occurring after the authorizing unlocking of the hardware wallet. The accessing may include prompting, by the hardware wallet, a user to enter a personal identification number. The accessing may include receiving, by the hardware wallet, the personal identification number. The accessing may include verifying, by the hardware wallet, that the received personal identification number is correct. Various elements may be performed in response to the verifying. For instance, the method may continue with decrypting, from the signed wallet unlocking command, the first wallet unlocking command, by the public first unlocking key to reveal the first wallet unlocking command, and executing, by the hardware wallet, the first wallet unlocking command.

A cryptocurrency wallet controller is disclosed. The wallet controller may configure a hardware wallet for control by the cryptocurrency wallet controller. The cryptocurrency wallet controller may include a transceiver configured to electronically communicate with the hardware wallet to communicate cryptographic keys to the hardware wallet. The cryptocurrency wallet controller may include a digital storage unit configured to securely store at least a portion of the cryptographic keys. The cryptocurrency wallet controller may include a processor in electronic communication with the digital storage unit and the transceiver. The processor may be configured to perform various methods. For instance, the processor may be configured to generate a master signing key pair including a private master signing key and a public master signing key. The processor may generate a first unlocking key pair comprising a private first unlocking key and a public first unlocking key. The processor may sign, the public first unlocking key with the private master signing key to create a signed public first unlocking key. The processor may transmit, by the transceiver, the public master signing key to the hardware wallet. The processor may transmit, by the transceiver, the signed public first unlocking key to the hardware wallet. The processor stores the private master signing key and the private first unlocking key in the digital storage unit. The private master signing key and the private first unlocking key are not transmitted from the cryptocurrency wallet controller to the hardware wallet.

In various embodiments, further features are provided. the processor may be further configured to transmit, from the first wallet controller, the private master signing key to a second wallet controller. The second wallet controller may generate a second unlocking key pair having a private second unlocking key and a public second unlocking key. The second wallet controller may sign the public second unlocking key with the private master signing key to create a signed public second unlocking key. The second wallet controller may transmit, from the second wallet controller to the hardware wallet, the signed public second unlocking key. In various embodiments, the first wallet controller and the second wallet controller are software applications running on a same device, wherein the transmitting from the first wallet controller the private master signing key to the second wallet controller includes accessing a shared trusted execution environment containing the private master signing key by both the first wallet controller and the second wallet controller.

### BRIEF DESCRIPTION OF THE DRAWINGS

Other systems, methods, features, and advantages of the present invention will be apparent to one skilled in the art upon examination of the following figures and detailed description. Component parts shown in the drawings are not necessarily to scale and may be exaggerated to better illustrate the important features of the present invention.

FIG. 1 depicts a block diagram of a wallet control system, in accordance with various embodiments;

FIG. 2 depicts various keys of the wallet control system, in accordance with various embodiments;

FIG. 3 depicts various communication channels of the wallet control system, in accordance with various embodiments;

FIG. 4 depicts a method of configuring a hardware wallet for secure control by a first wallet controller, in accordance with various embodiments;

FIG. 5 depicts a method of configuring a hardware wallet for secure control by a first and second wallet controller, in accordance with various embodiments;

FIG. 6 depicts a method for configuring a hardware wallet for control that also includes authorizing unlocking or other access control practices, in accordance with various embodiments;

FIG. 7 depicts a method for configuring a hardware wallet for control that also includes authorizing unlocking or other access control practices by a first and a second wallet controller, in accordance with various embodiments; and

FIG. 8 depicts a method of revoking a key associated with access to a hardware wallet, in accordance with various embodiments.

### DETAILED DESCRIPTION

As disclosed herein, systems, apparatuses, and methods for access and control of cryptocurrency wallets (crypto wallets) are provided.

Crypto wallets are used to generate and store cryptographic keys required for performing cryptocurrency transactions. Crypto wallets include at least two common varieties. Software wallets are crypto wallets that are a smartphone or desktop application that stores the cryptographic keys and also manages incoming and outgoing transactions. Hardware wallets are crypto wallets that have an embedded device that stores the private keys used for signing outgoing transactions. The hardware wallet communicates with a smartphone, desktop, or web application “watch-only wallet” that only stores the corresponding public keys of the hardware wallet's private keys. A watch-only wallet monitors incoming transactions and prepares unsigned outgoing transactions for the embedded device but cannot sign outgoing transactions. The embedded device verifies the transaction details, retrieves the applicable signing key, signs the transaction, and sends the signed transaction back to the smartphone, desktop, or web application to be broadcast to mining nodes.

Hardware crypto wallets are known to be more secure than software crypto wallets because the software crypto wallets coexist with other applications on a smartphone or desktop and thus the private keys are susceptible to software attacks on the shared platform, while the keys in a hardware crypto wallet never leave the embedded device. Access to hardware crypto wallet operations is often protected by a personal identification number (PIN).

As mentioned, prior crypto wallets rely on a personal identification number (PIN) being correctly entered, and often delete the wallet's information in response to an excessive number of incorrect PIN entries. This generates a variety of problems. For instance, the owner may forget the PIN and lose access to the device. If a bad actor gains physical access to the device, for example while the device is temporary left unattended, the bad actor may try to guess the PIN. In some cases, the PIN can be either stolen or easily guessed, for example if the PIN is part of the owner's birthday date or phone number or used elsewhere by the owner. If the bad actor can correctly guess the wallet's PIN within a few attempts, the bad actor may steal all the wallet's cryptocurrency. If the bad actor cannot guess the PIN correctly, then the bad actor may still force a device reset after a few successive incorrect PIN attempts in a trivial denial-of-service attack. In such a case, the owner must restore the wallet's seed value from a backup, or otherwise loses their cryptocurrency.

The restoration process brings the following additional risks. For instance, the restoration process could be a tedious and undesirable task, for example when done via a recovery seed phrase. If the owner does not have instant access to the backup source, it may result in a possible opportunity loss. If the owner loses their backup, the wallet's cryptocurrency may be lost forever.

To address these challenges, and other challenges, a variety of access control systems and methods for crypto wallets are provided. For instance, a wallet owner may opt in the use of a smartphone application that communicates with the hardware wallet over Bluetooth Low Energy (BLE) to unlock the embedded device, either in addition or as an alternative to the device's PIN. As an initial step, the application may create a device-unlock signing key and shares the corresponding public key with the embedded device. Later, whenever it is required to unlock the device, the application may send a digitally signed unlocking command to the device. The signing key may be coupled with the owner's confirmation via the biometrics, PIN or pattern set on the smartphone.

If an application authentication is used in addition to the PIN, the embedded device should authenticate the application first before offering the owner to enter the PIN to mitigate PIN attacks. If the application authentication is used as an alternative to the PIN, the embedded device will not request the PIN if the application authentication is successful but will still require that the owner physically confirms the unlock process, for example by pressing on two buttons simultaneously.

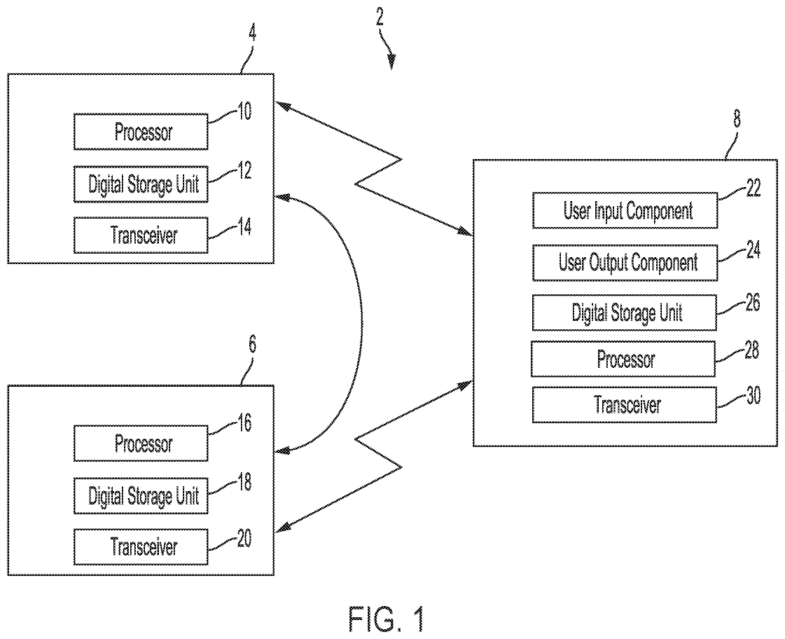

An example system for backup and recovery of a crypto wallet may have different devices that work in concert to perform these mechanisms. Directing attention now to FIG. 1, an access control system 2 for a crypto wallet may include one or more hardware wallet 8. A hardware wallet 8 may be a hardware crypto wallet embedded device. For instance, the hardware wallet 8 may have processing, communication, and memory capabilities. The access control system 2 may include one or more wallet controller. For instance, FIG. 1 depicts a first wallet controller 4 and a second wallet controller 6, though any number of wallet controllers may be provided. A wallet controller may be a device able to control cryptocurrency transactions in concert with the hardware wallet 8. The wallet controller may be a device able to configure a hardware wallet 8 for access.

The discussion will now consider hardware wallet 8, first wallet controller 4, and second wallet controller 6 in greater detail. In various embodiments, the hardware wallet 8 may include a processor 28. The processor 28 may be a computer processor, a microprocessor, or any other electronic device configured to perform calculations. The hardware wallet 8 may include a digital storage unit 26. The digital storage unit 26 may comprise an electronic memory. The memory may interoperate with the processor 28 to store data for future use and to retrieve data for present use. In various instances, the digital storage unit 26 may include securely stored keys or may include a PIN. The hardware wallet 8 may include a user input component 22. The user input component 22 may include one or more keyboard, pushbutton, touch sensitive element such as a touch screen, audio device, haptic device, or other human-machine interface capable of receiving input from a human. The hardware wallet 8 may include one or more user output component 24. The user output component 24 may include one or more visual display screen, light indicator, audio device, haptic device, or other human-machine interface capable of providing output to a human. The hardware wallet 8 may have a transceiver 30. The transceiver 30 may be a RF transceiver, a wired transceiver, a modem, or any other device configured to communicate with other devices such as first wallet controller 4 and second wallet controller 6, directly or via a network.

The first wallet controller 4 and the second wallet controller 6 are illustrated as block diagrams of hardware devices. First wallet controller 4 is illustrated with a processor 10, digital storage unit 12, and transceiver 14. Second wallet controller 6 is illustrated with a processor 16, a digital storage unit 18, and a transceiver 20. However, one may appreciate that each wallet controller may be a combination of hardware and software. For instance, in various embodiments, the first wallet controller 4 and the second wallet controller 6 are both software applications running on a computing device. As such, processor 10 and processor 16 may be a same processor of a computing device. Likewise, digital storage unit 12 and digital storage unit 18 may be a shared computer memory, or different portions (e.g., different addressable space) of a computer memory. Finally, transceiver 14 and transceiver 20 may be a same transceiver of a computing device.

Turning more specifically to the first wallet controller 4, the first wallet controller 4 may comprise a processor 10. The processor 10 may be a computer processor, a microprocessor, or any other electronic device configured to perform calculations. The first wallet controller 4 may include a digital storage unit 12. The digital storage unit 12 may comprise an electronic memory. The memory may interoperate with the processor 10 to store data for future use and to retrieve data for present use. In various instances, the digital storage unit 12 may include securely stored cryptographic keys. The first wallet controller 4 may include a transceiver 14. The transceiver 14 may be a RF transceiver, a wired transceiver, a modem, or any other device configured to communicate with other devices such as hardware wallet 8 and second wallet controller 6, directly or via a network.

Turning more specifically to the second wallet controller 6, the second wallet controller 6 may comprise a processor 16. The processor 16 may be a computer processor, a microprocessor, or any other electronic device configured to perform calculations. The second wallet controller 6 may include a digital storage unit 18. The digital storage unit 18 may comprise an electronic memory. The memory may interoperate with the processor 16 to store data for future use and to retrieve data for present use. In various instances, the digital storage unit 18 may include securely stored cryptographic keys. The second wallet controller 6 may include a transceiver 20. The transceiver 20 may be a RF transceiver, a wired transceiver, a modem, or any other device configured to communicate with other devices such as hardware wallet 8 and first wallet controller 4, directly or via a network.

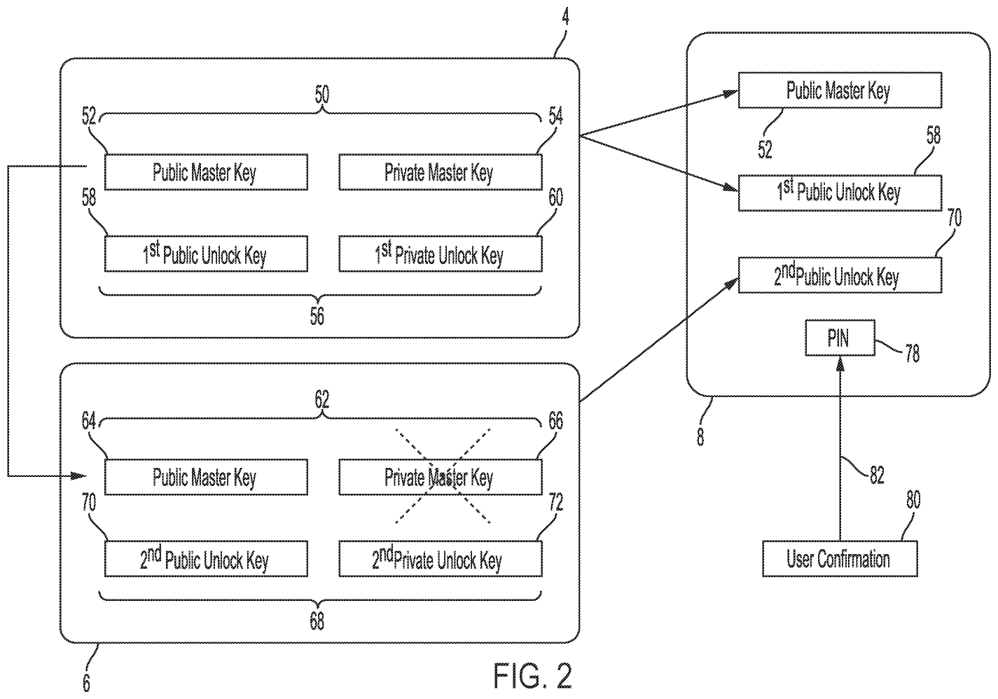

Turning now to FIG. 2, but with continuing reference also to FIG. 1, an illustration of various data and the association of the various data with the different devices is shown. Arrows are illustrated to depict various transmissions of data from one device to another device. For example, the processor 10 of the first wallet controller 4 may generate cryptographic keys. In other embodiments, the cryptographic keys are received from another system, network, or device. The first wallet controller 4 may store the cryptographic keys in the digital storage unit 12.

The keys may be asymmetric cryptography keys. Asymmetric cryptography (e.g., public-key cryptography) uses a pair of related keys to encrypt and decrypt data. Typically, the public key may be used by any machine to encrypt the message so that it can be decrypted only by a holder of a corresponding private key. Similarly, if a holder of a private key encrypts a message using the private key, the message may be decrypted using the corresponding public key. Based on the presumption that the private key is only under control of a genuine sender of the message, the decryptability by the private key also verifies the provenance of the message.

The first wallet controller 4 may have a master signing key pair 50. The master signing key pair 50 may have a public master signing key 52 and a private master signing key 54. The master signing key pair 50 may be used to sign and/or encrypt messages. The first wallet controller 4 may have a first unlocking key pair 56. The first unlocking key pair 56 may have a public first unlocking key 58 and a private first unlocking key 60. The first unlocking key pair 56 may be used in connection with sending unlocking messages to the hardware wallet 8 instructing it to “unlock” so that cryptocurrency transactions may be executed in connection with a cryptocurrency addressed or otherwise controlled by the hardware wallet 8.

The second wallet controller 6 may have a master signing key pair 62. The master signing key pair 62 may be identical to the master signing key pair 50 of the first wallet controller 4. The master signing key pair 62 may include a public master signing key 64 and a private master signing key 66. In various embodiments, the private master signing key 66 may be omitted. For instance, the private master signing key 66 may be exclusively stored in the first wallet controller 4 so that the second wallet controller 6 does not have and cannot access the private master signing key 66. This is illustrated by the dashed lines forming an X over the private master signing key 66. In further embodiments, the private master signing key 66 is not omitted and is identical to the master signing key pair 50. The master signing key pair 62 may be used to sign and/or encrypt messages. The second wallet controller 6 may have a second unlocking key pair 68. The second unlocking key pair 68 may have a public second unlocking key 70 and a private second unlocking key 72. The second unlocking key pair 68 may be used in connection with sending unlocking messages to the hardware wallet 8 instructing it to “unlock” so that cryptocurrency transactions may be executed in connection with a cryptocurrency addressed or otherwise controlled by the hardware wallet 8.

Thus, one may appreciate that the first wallet controller 4 and the second wallet controller 6 may both have access to the master signing key pair and pairs 62 and 50 may be a single key pair. For instance, each wallet controller may be a software application running on a device having the master signing key pair stored securely in a trusted execution environment (TEE) or a secure element (SE). Notably, the first wallet controller 4 and the second wallet controller 6 may limit access to the first unlocking key pair 56 and the second unlocking key pair 68. For instance, the first wallet controller 4 has access to the first unlocking key pair 56 but does not have access to the second unlocking key pair 68. Similarly, the second wallet controller 6 has access to the second unlocking key pair 68 but does not have access to the first unlocking key pair 56. Various other arrangements may also be contemplated to further improve security of keys.

The hardware wallet 8 may also store various keys in the digital storage unit 26 of the hardware wallet 8. The first wallet controller 4 may utilize its transceiver 14 to communicate with the transceiver 30 of the hardware wallet 8 to send various keys for storage in the digital storage unit 26 of the hardware wallet 8. Similarly, the second wallet controller 6 may utilize its transceiver 20 to communicate with the transceiver 30 of the hardware wallet 8 to send various keys for storage in the digital storage unit 26 of the hardware wallet 8. The first wallet controller 4 may provide a public master signing key 52 and a public first unlocking key 58 to the hardware wallet 8. The second wallet controller 6 may provide a public second unlocking key 70 to the hardware wallet 8. Finally, a hardware wallet 8 may have a user input component 22 to receive entry of a personal identification number (PIN) to verify custody and/or control of the hardware wallet 8 prior to various actions, such as unlocking of the hardware wallet 8. A hardware wallet 8 may receive a user confirmation 80, such as a PIN 78 via entry on the user input component 22, such entry illustrated by an arrow 82 (third communication channel 82, discussed below).

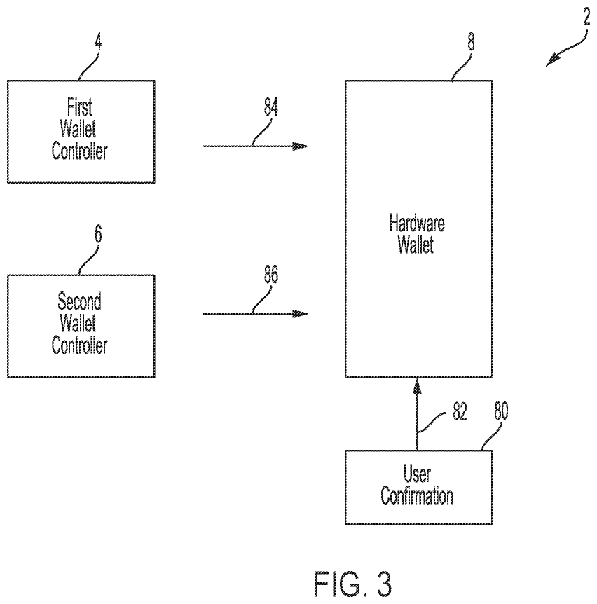

The hardware wallet 8 may, in concert with one or both of the first wallet controller 4 and the second wallet controller 6 perform various operations that utilize communication between and/or among devices. With reference to FIG. 3 (and ongoing reference to FIGS. 1-2), the first wallet controller 4 instantiate a first communication channel 84 with the hardware wallet 8 to send and receive commands and/or keys. The second wallet controller 6 may instantiate a second communication channel 86 with the hardware wallet 8 to send and receive commands and/or keys. The user confirmation 80 may proceed via a third communication channel 82 to interact with the hardware wallet 8. In various instances, the first communication channel 84 is a wireless connection between the transceiver 14 of the first wallet controller 4 and the transceiver 30 of the hardware wallet 8. In various instances, the second communication channel 86 is a wireless connection between the transceiver 20 of the second wallet controller 6 and the transceiver 30 of the hardware wallet 8. In various instances, the third communication channel 82 may be a physical interaction of a user providing a user confirmation 80 with the user input component 22 of the hardware wallet 8 such as by pressing buttons or entering a PIN.

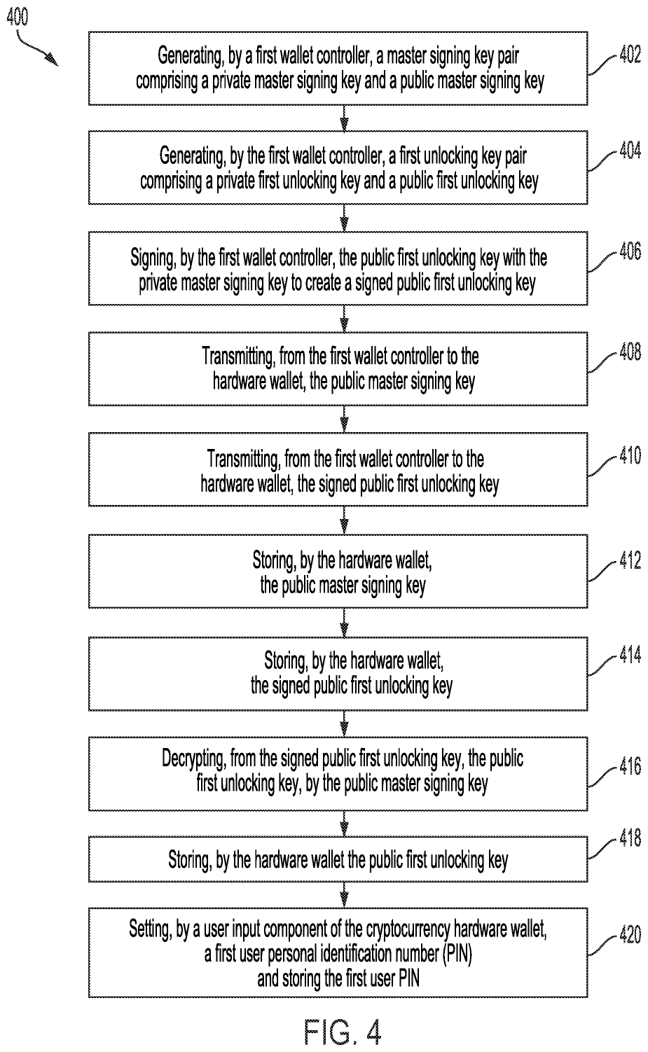

Having introduced aspects of the first wallet controller 4, the second wallet controller 6, the hardware wallet 8 and communication among the first wallet controller 4, the second wallet controller 6, and the hardware wallet 8, various methods may be executed by one or more of these devices in order to control access to cryptocurrency associated with the hardware wallet 8. For example, with reference to FIG. 4 and ongoing reference to FIGS. 1-3, a method 400 may be provided for setting up the hardware wallet 8 for secure control by one or both of the first wallet controller 4 and the second wallet controller 6. A method 400 of configuring a hardware wallet 8 for control may include generating keys. In further instances, the keys are generated by another device and are provided to the access control system 2. For instance, the method may include generating, by a first wallet controller 4, a master signing key pair 50 comprising a public master signing key 52 and a private master signing key 54 (block 402). The method may also include generating, by the first wallet controller 4, a first unlocking key pair 56 comprising a public first unlocking key 58 and a private first unlocking key 60 (block 404).

The first wallet controller 4 may sign the public first unlocking key 58 with the private master signing key 54 to create a signed public first unlocking key (block 406). “Signing” data may include applying cryptographic calculations, such as encrypting the data. The first wallet controller 4 may transmit the public master signing key 52 to the hardware wallet 8 (block 408). The first wallet controller 4 may transmit the signed public first unlocking key to the hardware wallet 8 (block 410). Notably, the first wallet controller 4 may refrain from transmitting the private master signing key 54 and may refrain from transmitting the private first unlocking key 60 to any other device. Similarly, the first wallet controller 4 may refrain from transmitting the public first unlocking key 58 to any other device. Because the transmitted key in block 410 is signed, that key is encrypted during transmission and is transmitted securely.

The hardware wallet 8 may take various steps after receiving the public master signing key 52 and the signed public first unlocking key. For instance, the hardware wallet 8 may store the public master signing key 52 (block 412). The hardware wallet 8 may also store the signed public first unlocking key (block 414). The hardware wallet 8 may decrypt, from the signed public first unlocking key, the public first unlocking key 58 by the public master signing key 52 (block 416). Having recovered the public first unlocking key 58 in unencrypted form, the hardware wallet 8 may store the public first unlocking key 58 (block 418). Now, the hardware wallet 8 has the capability to decrypt messages that are encrypted with the private first unlocking key 60. The provenance of such messages as originating from the first wallet controller 4, as well as the content of the messages may be securely revealed by the hardware wallet 8 now that the hardware wallet 8 has a local copy of the private first unlocking key 60. The hardware wallet 8 may also set, by a user input component 22 of the hardware wallet 8, a first user personal identification number (PIN) and may store the first user PIN (block 420). This PIN may also facilitate verifying positive control of the hardware wallet 8 by an authorized individual and may be requested by the hardware wallet 8 for re-entry prior to various actions, such as unlocking.

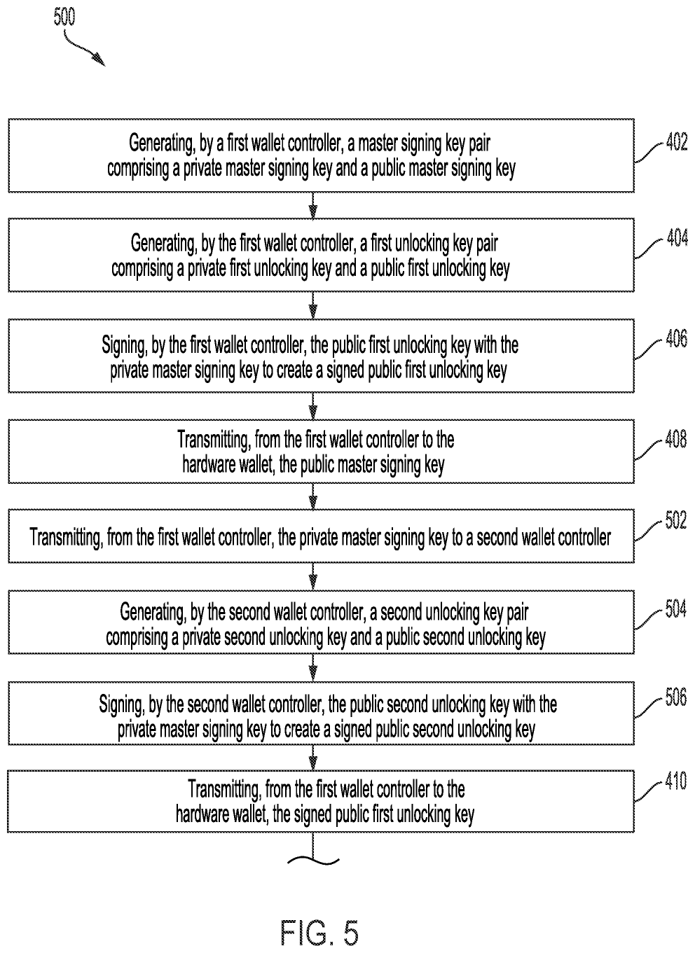

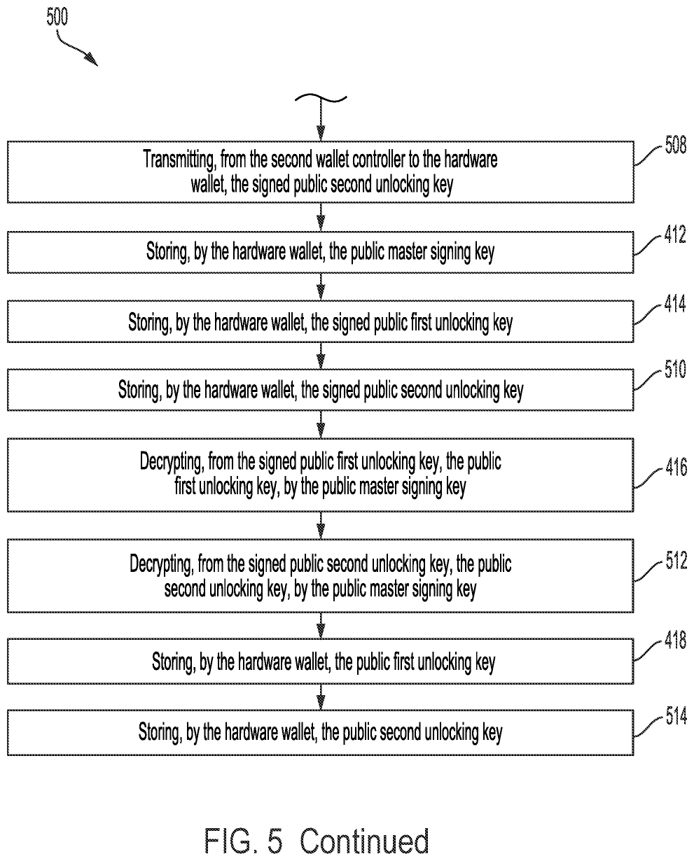

In various embodiments, the first wallet controller 4 may also operate to set up the hardware wallet 8 for secure control by both the first wallet controller 4 and the second wallet controller 6. With reference to FIG. 5, and with ongoing reference to FIGS. 1-3, a method 500 for setting up the hardware wallet 8 for secure control by both of the first wallet controller 4 and the second wallet controller 6 is provided. In this method, some aspects of the method 400 (FIG. 4) described in reference to FIG. 4 are repeated with like block numbers, and some aspects are different.

In various embodiments, a method 500 for configuring a hardware wallet 8 for control by both the first wallet controller 4 and the second wallet controller 6 may include generating keys. In further instances, the keys are generated by another device and are provided to the access control system 2. For instance, the method may include generating, by a first wallet controller 4, a master signing key pair 50 comprising a public master signing key 52 and a private master signing key 54 (block 402). The method may also include generating, by the first wallet controller 4, a first unlocking key pair 56 comprising a public first unlocking key 58 and a private first unlocking key 60 (block 404).

The first wallet controller 4 may sign the public first unlocking key 58 with the private master signing key 54 to create a signed public first unlocking key (block 406). “Signing” data may include applying cryptographic calculations, such as encrypting the data. The first wallet controller 4 may transmit the public master signing key 52 to the hardware wallet 8 (block 408). The first wallet controller 4 may transmit from the first wallet controller 4, the private master signing key 54 to a second wallet controller 6 (block 502). The second wallet controller 6 may generate a second unlocking key pair 68 comprising a private second unlocking key 72 and a public second unlocking key 70 (block 504). The second wallet controller 6 may sign the public second unlocking key 70 with the private master signing key 66 to create a signed public second unlocking key (block 506).

The first wallet controller 4 may transmit the signed public first unlocking key to the hardware wallet 8 (block 410). The second wallet controller 6 may transmit the signed public second unlocking key to the hardware wallet 8 (block 508).

Notably, the first wallet controller 4 may refrain from transmitting the private master signing key 54 and may refrain from transmitting the private first unlocking key 60 to the hardware wallet 8. Similarly, the second wallet controller 6 may refrain from transmitting the private master signing key 66 and may refrain from transmitting the private second unlocking key 72 to the hardware wallet 8. Because the transmitted key in block 410 is signed, that key is encrypted during transmission and is transmitted securely. Because the transmitted key in block 508 is signed, that key is encrypted during transmission and is transmitted securely.

The hardware wallet 8 may take various steps after receiving one or more of the public master signing key 52, the signed public first unlocking key, and the signed public second unlocking key. For instance, the hardware wallet 8 may store the public master signing key 52 (block 412). The hardware wallet 8 may also store the signed public first unlocking key (block 414). The hardware wallet 8 may store the signed public second unlocking key (block 510).

The hardware wallet 8 may decrypt, from the signed public first unlocking key, the public first unlocking key 58 by the public master signing key 52 (block 416). The hardware wallet 8 may decrypt, from the signed public second unlocking key, the public second unlocking key 70, by the public master signing key 52 (block 512).

Having recovered the public first unlocking key 58 in unencrypted form, the hardware wallet 8 may store the public first unlocking key 58 (block 418). Having recovered the public second unlocking key 70 in unencrypted form, the hardware wallet 8 may store the public second unlocking key 70 (block 514).

Now, the hardware wallet 8 has the capability to decrypt messages that are encrypted with the private first unlocking key 60 and to decrypt messages that are encrypted with the private second unlocking key 72. The provenance of such messages as originating from the first wallet controller 4 and from the second wallet controller 6, as well as the content of the messages may be securely revealed by the hardware wallet 8 now that the hardware wallet 8 has a local copy of the private first unlocking key 60 and the private second unlocking key 72. The hardware wallet 8 may also set, by a user input component 22 of the hardware wallet 8, a first user personal identification number (PIN) and may store the first user PIN. This PIN may also facilitate verifying positive control of the hardware wallet 8 by an authorized individual and may be requested by the hardware wallet 8 for re-entry prior to various actions, such as unlocking.

The preceding methods focus on establishing secure access among the hardware wallet 8, the first wallet controller 4, and/or the second wallet controller 6 by the exchange of various keys. In the following paragraphs, the discussion will continue with explanations of various mechanisms for controlling the hardware wallet 8 by controllers with established access. One may appreciate that while these mechanisms are discussed with reference to their own figures and blocks, aspects may be combined with, or used subsequently to, the methods already discussed.

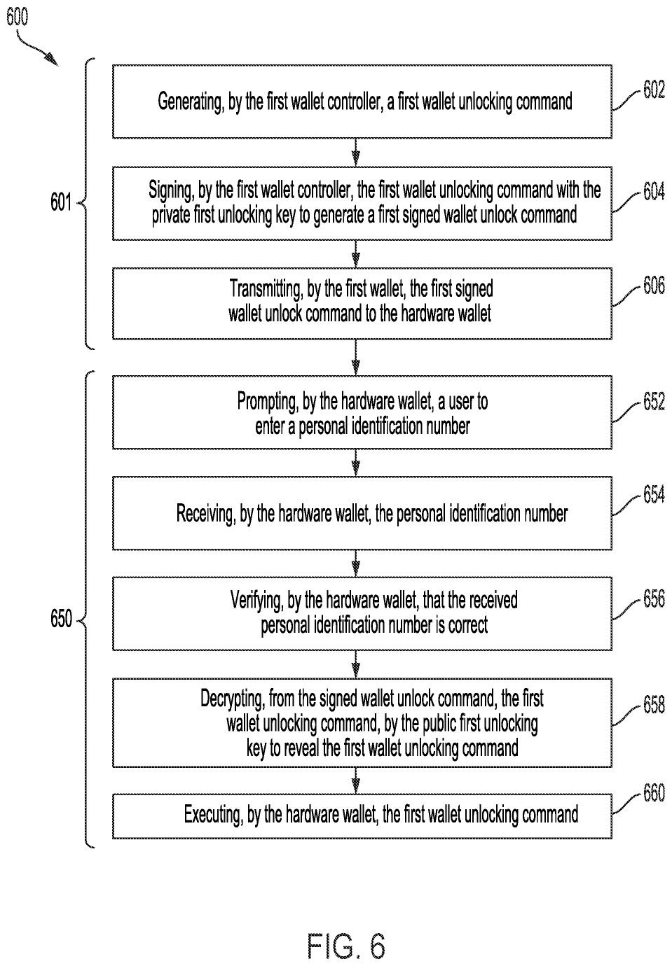

For instance, with reference to FIG. 6 and ongoing reference to FIGS. 1-3, a method of configuring a hardware wallet 8 for control may include further steps associated with authorizing unlocking or other access control practices. For instance, a method 600 may comprise a continuation of a method 400 or a method 500 (FIGS. 4, and 5). In various embodiments, a method 600 may include authorizing unlocking of a hardware wallet 8 by a first wallet controller 4 to allow access to secured data comprising cryptocurrency (block 601). The authorizing may include various further aspects. The method 600 may include accessing the secured data comprising cryptocurrency, the accessing occurring after the authorizing unlocking of the hardware wallet 8 (block 650). The accessing may also include various further aspects.

In various embodiments the authorizing (block 601) may include generating, by a first wallet controller 4, a first wallet unlocking command (block 602). An unlocking command may be a command to permit access to transfer of, or transactions with cryptocurrency associated with the wallet. The method may include signing, by the first wallet controller 4, the first wallet unlocking command with the private first unlocking key 60 to generate a first signed wallet unlocking command (block 604). The first wallet controller 4 may transmit the first signed wallet unlocking command to the hardware wallet 8 (block 606).

In various embodiments, the accessing (block 650) may include prompting, by the hardware wallet 8, a user to enter a PIN (block 652). The hardware wallet 8 may receive the PIN (block 654) and may verify that the received PIN is correct (block 656). Responsive to verifying that the received PIN is correct, the hardware wallet 8 may decrypt, from the signed wallet unlocking command, the first wallet unlocking command, by the public first unlocking key 58 to reveal the first wallet unlocking command (block 658). The hardware wallet 8 may execute the first wallet unlocking command (block 660).

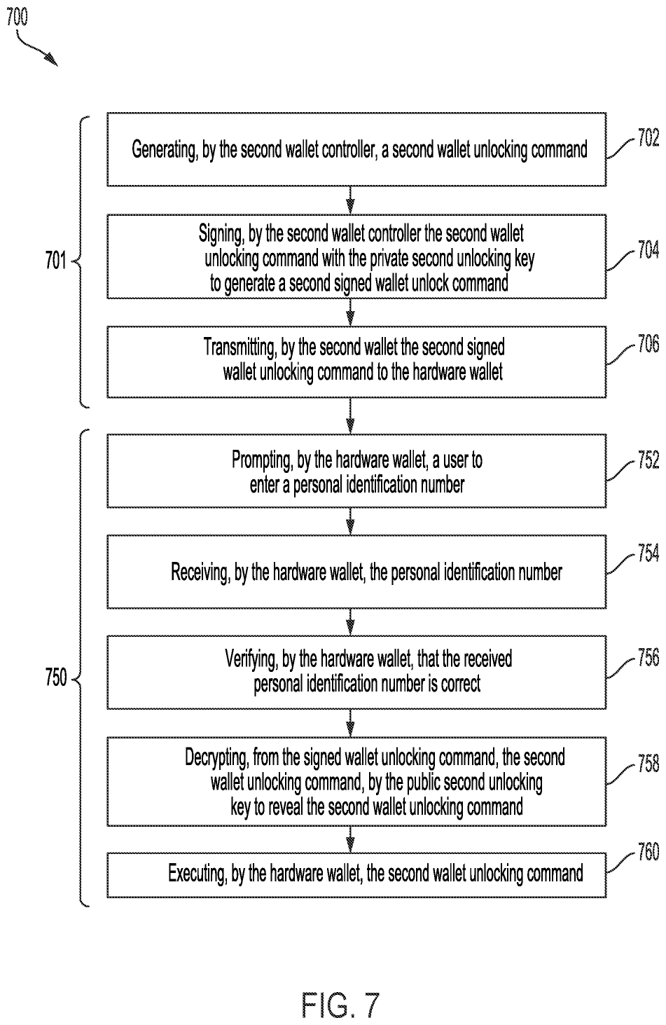

Turning now to FIG. 7 and ongoing reference to FIGS. 1-3, a method of configuring a hardware wallet 8 for control may include further steps associated with authorizing unlocking or other access control practices that permits unlocking or access control practices by a second wallet controller 6. Such access by the second wallet controller 6 may be in addition to access by a first wallet controller 4. Thus, in various embodiments, a method 700 may comprise a continuation of a method 400, or a method 500, or a method 600 (FIGS. 4-6). In various embodiments, a method 700 may include authorizing unlocking of a hardware wallet 8 by a second wallet controller 6 to allow access to secured data comprising cryptocurrency (block 701). The authorizing may include various further aspects. The method 700 may include accessing the secured data comprising cryptocurrency, the accessing occurring after the authorizing unlocking of the hardware wallet 8 by the second wallet controller 6 (block 750). The accessing may also include various further aspects.

In various embodiments, the authorizing (block 701) may include generating, by a second wallet controller 6, a second wallet unlocking command (block 702). An unlocking command may be a command to permit access to transfer of, or transactions with cryptocurrency associated with the wallet. The method may include signing, by the second wallet controller 6, the second wallet unlocking command with the private second unlocking key 72 to generate a second signed wallet unlocking command (block 704). The second wallet controller 6 may transmit the second signed wallet unlocking command to the hardware wallet 8 (block 706).

In various embodiments, the accessing (block 750) may include prompting, by the hardware wallet 8, a user to enter a PIN (block 752). The hardware wallet 8 may receive the PIN (block 754) and may verify that the received PIN is correct (block 756). Responsive to verifying that the received PIN is correct, the hardware wallet 8 may decrypt, from the signed wallet unlocking command, the second wallet unlocking command, by the public second unlocking key 70 to reveal the second wallet unlocking command (block 758). The hardware wallet 8 may execute the second wallet unlocking command (block 760).

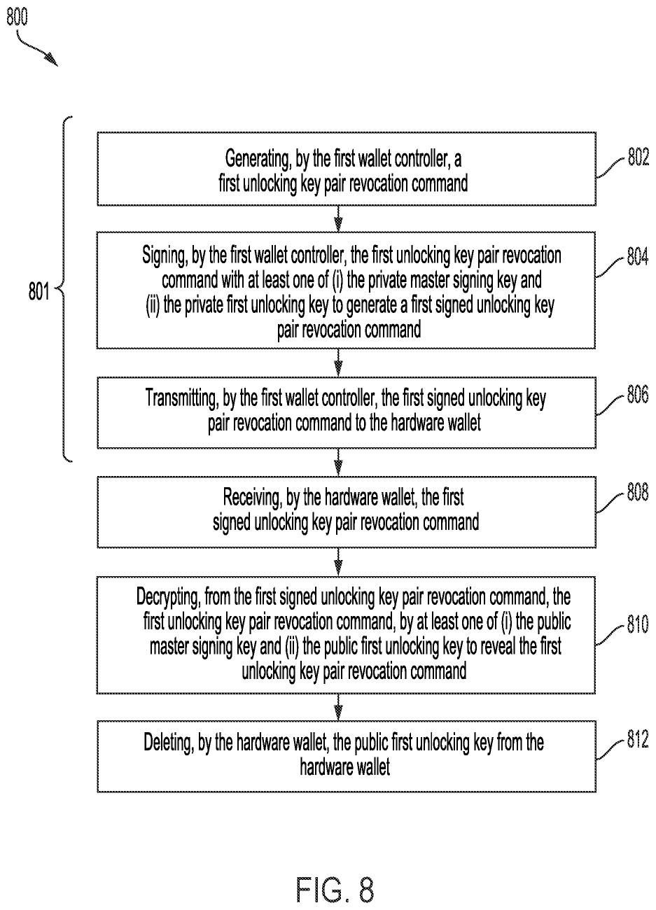

In various embodiments, keys may be revoked so that access to the hardware wallet 8 by the first wallet controller 4 or the second wallet controller 6 can be terminated. For instance, referring to FIG. 8, and with periodic reference to FIGS. 1-3, a method 800 of key revocation may be provided. The method may comprise a continuation of a method 400, or a method 500 or a method 600 or a method 700 (FIGS. 4-7). The method 800 may include revoking the first unlocking key pair 56 (block 801).

Revoking the first unlocking key pair 56 may include various steps. For instance, the revoking (block 801) may include generating, by the first wallet controller 4, a first unlocking key pair revocation command (block 802). The method may include signing, by the first wallet controller 4 the first unlocking key pair revocation command with at least one of (i) the private master signing key 54 and (ii) the private first unlocking key 60 to generate a first signed unlocking key pair revocation command (block 804). The method may include transmitting, by the first wallet controller 4, the first signed unlocking key pair revocation command to the hardware wallet 8 (block 806).

Following the revoking of the first unlocking key pair 56 and related transmission of the revocation command to the hardware wallet 8, the method may continue. The method may include receiving, by the hardware wallet 8, the first signed unlocking key pair revocation command (block 808). The hardware wallet 8 may decrypt, from the first signed unlocking key pair revocation command, the first unlocking key pair revocation command, by at least one of (i) the public master signing key 52 and/or (ii) the public first unlocking key 58 to reveal the first unlocking key pair revocation command (block 810). The hardware wallet 8 may delete the public first unlocking key 58 from the hardware wallet 8 (block 812) or may add the key to a list of banned keys or may perform another command associated with the first unlocking key pair revocation command.

The system may be implemented in a variety of different hardware configurations to execute the methods, in addition to those described above. The wallet controllers may be smartphone applications, and the smartphone may have a processor with a trusted execution environment (TEE). In other instances, a secure element (SE) is provided. One or more of the key pairs may be generated within the TEE or the SE, for enhanced security, such that the key is hardware-backed and cannot be retrieved outside a TEE. In various instances, one or more of the private keys are retained in a TEE. This also facilitates improved security when the first wallet controller and second wallet controller are different applications on a same hardware device. By retaining the key within the TEE or SE, both controllers may share access to the key, while the key is secured from retrieval outside the TEE or SE.

Moreover, in various instances, the wallet controllers may be smartphone applications which are configured to use an attestation service provided by the operating system to retrieve one or more digital certificate chains signed by the servers of the smartphone's operating system's manufacturer. This attestation may attest to the following (or a subset thereof): (1) the genuineness of the operating system and the device on which the application is running, (2) the identity of the application developer, (3) the authenticity of the application and that it has not been modified, (4) the generation of the unlock key pair inside the TEE, and/or (5) the ownership of the unlock key pair by the application. The application may send the certificate chains to the hardware wallet and the hardware wallet may store perform one or more action related to the certificate chains. For instance, the hardware wallet may store the attestation root keys provided by the smartphone's operating system's manufacturer. The hardware wallet may receive the certificates from the application, verify each certificate chain using the stored attestation root keys, and verify the attested contents of each certificate. Moreover, the application may monitor and log each signature by incrementing a monotonically increasing counter that is incremented for every signing operation. The application may further utilize one-time-use nonce obtained from the hardware device. In addition, an unlocked hardware device may relock itself after a duration of time, which may be configured by a user. These features further improve security of the system.

Finally, the hardware wallet may also permit manual manipulation of the keys. For instance, the hardware wallet may allow an owner to manually select and delete the master public key or one or more of the unlock public keys. The hardware wallet may allow an owner to manually change the device's PIN, or to control the unlock duration, or to change the unlock procedures using the device's buttons and screen while the device is unlocked. Thus, security may be further enhanced.

Exemplary embodiments of the methods/systems have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A method of configuring a hardware wallet for control, the method comprising:
generating, by a first wallet controller, a master signing key pair comprising a private master signing key and a public master signing key;
generating, by the first wallet controller, a first unlocking key pair comprising a private first unlocking key and a public first unlocking key;
signing, by the first wallet controller, the public first unlocking key with the private master signing key to create a signed public first unlocking key;
transmitting, from the first wallet controller to the hardware wallet, the public master signing key; and
transmitting, from the first wallet controller to the hardware wallet, the signed public first unlocking key.

2. The method of claim 1, further comprising:
storing, by the hardware wallet, the public master signing key;
storing, by the hardware wallet, the signed public first unlocking key;
decrypting, from the signed public first unlocking key, the public first unlocking key, by the public master signing key master signing key; and
storing, by the hardware wallet the public first unlocking key.

3. The method of claim 2, further comprising, setting, by a user input component of the hardware wallet, a first user personal identification number (PIN) and storing the first user PIN.

4. The method of claim 1, further comprising:
transmitting, from the first wallet controller, the private master signing key to a second wallet controller;
generating, by the second wallet controller, a second unlocking key pair comprising a private second unlocking key and a public second unlocking key;
signing, by the second wallet controller the public second unlocking key with the private master signing key to create a signed public second unlocking key; and
transmitting, from the second wallet controller to the hardware wallet, the signed public second unlocking key.

5. The method of claim 4, wherein transmitting the private master signing key from the first wallet controller to the second wallet controller comprises accessing a same trusted execution environment (TEE) by the first wallet controller and the second wallet controller.

6. The method of claim 4, further comprising:
storing, by the hardware wallet, the signed public second unlocking key;
decrypting, from the signed public second unlocking key, the public second unlocking key, by the public master signing key; and
storing, by the hardware wallet, the public second unlocking key.

7. The method of claim 3, further comprising:
authorizing unlocking of the hardware wallet to allow access to secured data comprising cryptocurrency, the authorizing comprising:
generating, by the first wallet controller, a first wallet unlocking command;
signing, by the first wallet controller, the first wallet unlocking command with the private first unlocking key to generate a first signed wallet unlocking command; and
transmitting, by the first wallet controller, the first signed wallet unlocking command to the hardware wallet.

8. The method of claim 7, further comprising:
accessing the secured data comprising cryptocurrency, the accessing occurring after the authorizing unlocking of the hardware wallet and comprising:
prompting, by the hardware wallet, a user to enter a personal identification number;
receiving, by the hardware wallet, the personal identification number;
verifying, by the hardware wallet, that the received personal identification number is correct;
in response to the verifying:
decrypting, from the signed wallet unlocking command, the first wallet unlocking command, by the public first unlocking key to reveal the first wallet unlocking command; and
executing, by the hardware wallet, the first wallet unlocking command.

9. The method of claim 6, further comprising:
authorizing unlocking of the hardware wallet to allow access to secured data comprising cryptocurrency, the authorizing comprising:
generating, by the second wallet controller, a second wallet unlocking command;
signing, by the second wallet controller the second wallet unlocking command with the private second unlocking key to generate a second signed wallet unlocking command; and
transmitting, by the second wallet the second signed wallet unlocking command to the hardware wallet.

10. The method of claim 9, further comprising:
accessing the secured data comprising cryptocurrency, the accessing occurring after the authorizing unlocking of the hardware wallet and comprising:
prompting, by the hardware wallet, a user to enter a personal identification number;
receiving, by the hardware wallet, the personal identification number;
verifying, by the hardware wallet, that the received personal identification number is correct;
in response to the verifying:
decrypting, from the signed wallet unlocking command, the second wallet unlocking command, by the public second unlocking key to reveal the second wallet unlocking command; and
executing, by the hardware wallet, the second wallet unlocking command.

11. The method of claim 7 further comprising:
revoking the first unlocking key pair, the revoking comprising:
generating, by the first wallet controller, a first unlocking key pair revocation command;
signing, by the first wallet controller, the first unlocking key pair revocation command with at least one of (i) the private master signing key and (ii) the private first unlocking key to generate a first signed unlocking key pair revocation command; and
transmitting, by the first wallet controller, the first signed unlocking key pair revocation command to the hardware wallet.

12. The method of claim 11, wherein the revoking further comprises:
receiving, by the hardware wallet the first signed unlocking key pair revocation command;
decrypting, from the first signed unlocking key pair revocation command, the first unlocking key pair revocation command, by at least one of (i) the public master signing key and (ii) the public first unlocking key to reveal the first unlocking key pair revocation command; and
deleting, by the hardware wallet, the public first unlocking key from the hardware wallet.

13. A method of configuring a hardware wallet for control by a first wallet controller, the method comprising:
receiving, by a hardware wallet and from a first wallet controller, a public master signing key from a master signing key pair comprising a private master signing key and the public master signing key;
receiving, by the hardware wallet and from the first wallet controller, a signed public first unlocking key comprising a public first unlocking key from a first unlocking key pair comprising a private first unlocking key and a public first unlocking key, wherein the public first unlocking key is signed by the private master signing key;
storing, by the hardware wallet, the public master signing key;
storing, by the hardware wallet, the signed public first unlocking key;
decrypting, from the signed public first unlocking key, the public first unlocking key, by the public master signing key master signing key; and
storing, by the hardware wallet the public first unlocking key.

14. The method of claim 13, further comprising setting, by a user input component of the hardware wallet, a first user personal identification number (PIN) and storing the first user PIN.

15. The method of claim 14, further comprising:
authorizing unlocking of the hardware wallet to allow access to secured data comprising cryptocurrency, the authorizing comprising:
receiving, by the hardware wallet and from the first wallet controller, a first signed wallet unlocking command, wherein the first signed wallet unlocking command comprises a first wallet command that is signed by the first wallet controller with the private first unlocking key.

16. The method of claim 15, further comprising:
accessing, by the hardware wallet, secured data comprising cryptocurrency, the accessing occurring after the authorizing unlocking of the hardware wallet and comprising:
prompting, by the hardware wallet, a user to enter a personal identification number;
receiving, by the hardware wallet, the personal identification number;
verifying, by the hardware wallet, that the received personal identification number is correct;
in response to the verifying:
decrypting, from the signed wallet unlocking command, the first wallet unlocking command, by the public first unlocking key to reveal the first wallet unlocking command; and
executing, by the hardware wallet, the first wallet unlocking command.

17. A cryptocurrency wallet controller to configure a hardware wallet for control by the cryptocurrency wallet controller, the cryptocurrency wallet controller comprising:
a transceiver configured to electronically communicate with the hardware wallet to communicate cryptographic keys to the hardware wallet;
a digital storage unit configured to securely store at least a portion of the cryptographic keys;
a processor in electronic communication with the digital storage unit and the transceiver, wherein the processor is configured to:
generate a master signing key pair comprising a private master signing key and a public master signing key;
generate a first unlocking key pair comprising a private first unlocking key and a public first unlocking key;
sign, the public first unlocking key with the private master signing key to create a signed public first unlocking key;
transmit, by the transceiver, the public master signing key to the hardware wallet; and
transmit, by the transceiver, the signed public first unlocking key to the hardware wallet,
wherein the processor stores the private master signing key and the private first unlocking key in the digital storage unit, and
wherein the private master signing key and the private first unlocking key are not transmitted from the cryptocurrency wallet controller to the hardware wallet.

18. The cryptocurrency wallet controller of claim 17,
wherein the processor is further configured to transmit, from the first wallet controller, the private master signing key to a second wallet controller.

19. The cryptocurrency wallet controller of claim 18, wherein the second wallet controller:
generates, by the second wallet controller, a second unlocking key pair comprising a private second unlocking key and a public second unlocking key;
signs, by the second wallet controller, the public second unlocking key with the private master signing key to create a signed public second unlocking key; and
transmits, from the second wallet controller to the hardware wallet, the signed public second unlocking key.

20. The cryptocurrency wallet controller of claim 19, wherein both the first wallet controller and the second wallet controller are software applications running on a same device, wherein the transmitting from the first wallet controller the private master signing key to the second wallet controller comprises accessing a shared trusted execution environment containing the private master signing key by both the first wallet controller and the second wallet controller.
